(19) United States
(12) Patent Application Publication
(10) Pub. No.: US 2026/0229933 A1
(43) Pub. Date: Aug. 6, 2026

(54) ELECTRIC MACHINE WITH STATOR RETENTION SYSTEM

(71) Applicant: DANA TM4 INC., Boucherville (CA)

(72) Inventors: Benjamin POWELL, Austin, TX (US); Sabahattin DIZDAR, Montreal (CA); Nicolas BELANGER, Boucherville (CA); Guillaume PAYEUR, Boucherville (CA); Maxime MOISAN, Boucherville (CA); Simon BAKER-OSTIGUY, Montreal (CA); Rafaël BÉDARD, Otterburn Park (CA); Ryan D. NELMS, Weatherford, TX (US); Gaetan MARCEAU, Brossard (CA); Eric M. ENGERMAN, Plymouth, MI (US); Luke MILLER, Montreal (CA); Peter A. BEESLEY, Fort Wayne, IN (US)

(21) Appl. No.: 19/452,136

(22) Filed: Jan. 16, 2026

Related U.S. Application Data
(60) Provisional application No. 63/747,237, filed on Jan. 20, 2025.

(51) Int. Cl. H02K 1/18; H02K 5/24; H02K 15/02; H02K 15/40

(52) U.S. Cl. CPC H02K 1/18; H02K 5/24; H02K 15/02; H02K 15/40

(57) ABSTRACT

Systems and methods for an electric machine. The electric machine system includes, in one example, a housing circumferentially surrounding a stator, a cover removably coupled to the housing, and multiple shims and/or springs arranged between an axial end of the stator and the cover. In the system, the shims and/or springs preload the stator and a clearance fit is formed between an inner diameter of the housing and an outer diameter of the stator.

### CROSS-REFERENCE TO RELATED APPLICATION

The present application claims priority to U.S. Provisional Application No. 63/747,237, entitled “ELECTRIC MACHINE WITH STATOR RETENTION SYSTEM”, and filed on Jan. 20, 2025. The entire contents of the above-listed application are hereby incorporated by reference for all purposes.

### TECHNICAL FIELD

The present disclosure relates to an electric machine with a stator retention system.

### BACKGROUND AND SUMMARY

Electric motors are used in vehicles to generate motive power and in a variety of other fields. Many electric motors secure a stator within a housing using an interference fit interface. However, the inventors have recognized that in electric drives, previous techniques for location and retention of the stator assembly in the housing, such as a press-fit interface, constrain serviceability and/or compromise package space and add weight. Further, press fitting the stator into the motor housing makes it a permanent fixture with the housing structure.

Attempts have been made to bolt the stator in the housing. Bolting the stator into the housing makes it more serviceable, but significantly increases the sizes of the flange, the housing, and the stator laminations, adding significant weight and taking up valuable package space.

The inventors have recognized the aforementioned issues and developed an electric machine system to at least partially overcome the challenges. The electric machine system includes, in one example, a housing circumferentially surrounding a stator, a cover removably coupled to the housing, and multiple shims and/or springs arranged between an axial end of the stator and the cover. In the system, the shims and/or springs preload the stator and a clearance fit is formed between an inner diameter of the housing and an outer diameter of the stator.

In another example, an electric machine system is provided that includes a housing that circumferentially surrounds a stator and a threaded nut removably coupled to an axial side of the stator. Further, in the system, a clearance fit is formed between an inner diameter of the housing and an outer diameter of the stator.

In another example, an electric machine system is provided that includes a housing circumferentially surrounding a stator and a conical wedge device arranged between an inner diameter of the housing and an outer diameter of the stator.

The stators in the abovementioned systems are retained in a similar manner to a bolted stator, in the sense of providing axial clamp load through the stator laminations but do not demand large bosses on stator laminations or expanded cavity in motor housing to house long bolts along the entire length of stator, thereby increasing the system's space efficiency, if desired. Further, the systems described above allow the stator to be serviceable and enable a softer material to be used in the axial clamp direction to dampen some vibration from stator into housing connection points, if desired.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows a schematic depiction of an electric machine in a system.

FIG. 2 shows an example of an electric machine with a cover and a housing.

FIG. 3 shows another example of an electric machine with an intermediate cover plate.

FIG. 4 shows an example of an electric machine with stator clamping nuts.

FIGS. 5-6 show detailed illustrations of one of the stator clamping nuts, shown in FIG. 4.

FIG. 7 shows another example of an electric machine with a wedging ring.

### DETAILED DESCRIPTION

Electric machines with different stator retention techniques are described herein that enable the stator to be removably, securely, and space efficiently enclosed within a housing. In one example, shims and/or springs are arranged between a cover and a stator to axial clamp laminations in the stator. In another example, stator clamping nuts are removably coupled to opposing axial sides of a stator to clamp laminations in the stator. In yet another example, a wedging ring is arranged between an inner diameter of a housing and an outer diameter of a stator.

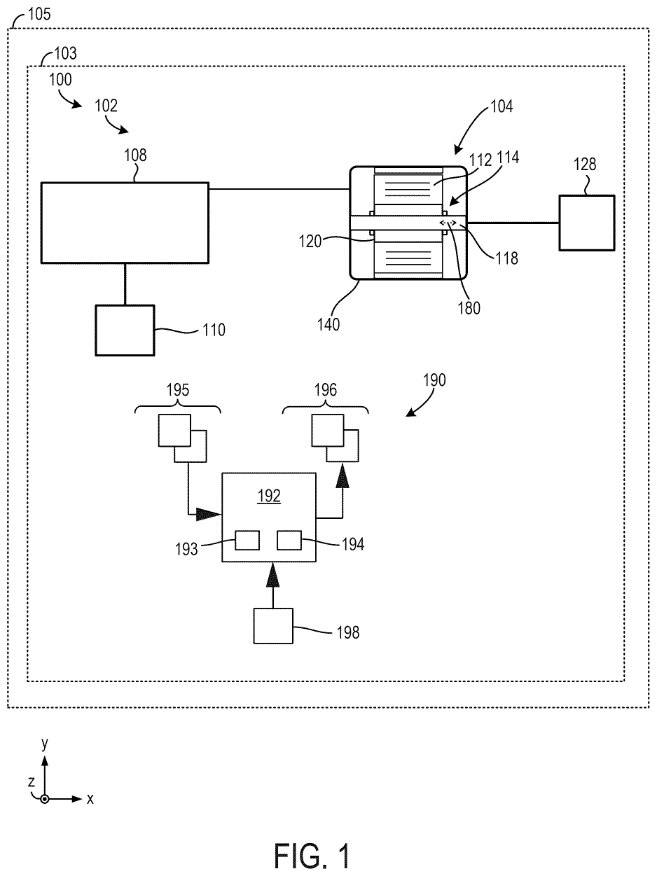

FIG. 1 shows an example of an electric drive 100 with an electric machine system 102. The electric drive 100 may be included in an electric powertrain 103 of a vehicle 105, in one example. In such an example, the electric machine included in the electric drive may be a traction motor. However, it will be understood that the electric drive 100 may be used in a variety of fields including, but not limited to, industrial machines, agricultural systems, mining systems, and the like.

In the electric drive 100, the inverter 108 is electrically coupled to the electric machine 104. The inverter 108 may be electrically connected to an energy storage device 110 (e.g., one or more traction batteries, capacitor(s), fuel cell(s), combinations thereof, and the like). As such, electrical energy may flow between the inverter and the energy storage device during drive operation and regeneration operation, when the electric machine 104 is designed as a motor-generator.

The electric machine 104 includes a stator 112 (e.g., a multi-phase stator) and a rotor 114. The rotor 114 includes a rotor shaft 118 and a rotor core 120. The rotor core 120 may include permanent magnets, in one example. In another example, the rotor core may be externally excited and therefore include electromagnets. The electric drive 100 may be coupled to downstream components 128. In the EV example, the downstream components 128 may include one or more drive axle assemblies, drive wheels, a transmission (e.g., a gearbox), combinations thereof, and the like.

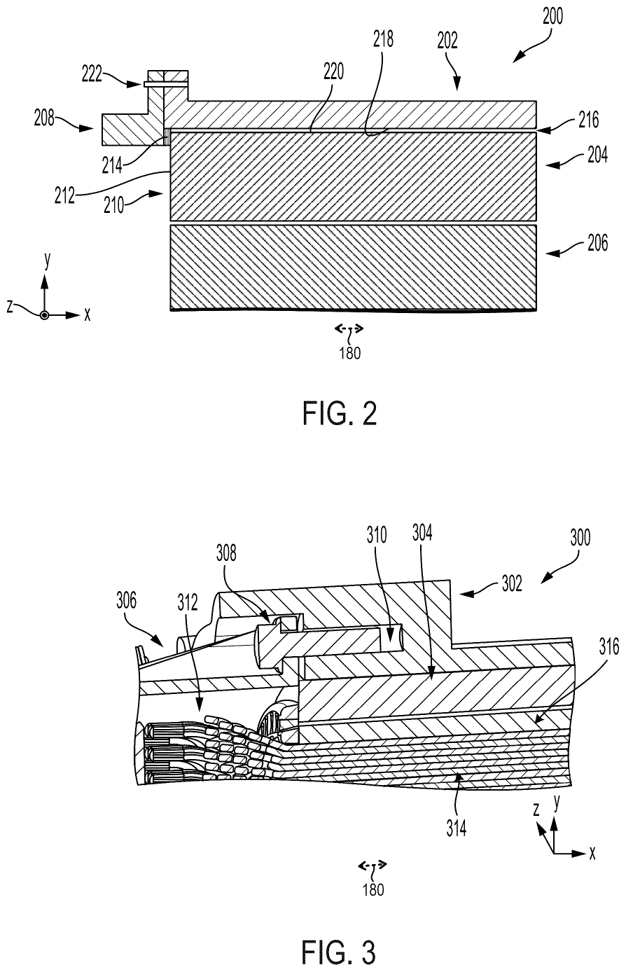

The electric machine 104 further includes a housing 140 that encloses the stator 112. Techniques for space efficiently and removably securing the stator within the housing are expanded upon herein with regard to FIGS. 2-7.

The electric drive 100 may further include a control system 190 with a controller 192 as shown in FIG. 1. The controller 192 may include a microcomputer with components such as a processor 193 (e.g., a microprocessor unit), input/output ports, an electronic storage medium 194 for executable programs and calibration values (e.g., a read-only memory chip, random access memory, keep alive memory, a data bus, and the like). The storage medium may be programmed with computer readable data that represents instructions that are executable by a processor for performing the methods and control techniques described herein as well as other variants that are anticipated but not specifically listed. As such, control techniques, methods, and the like expanded upon herein may be stored as instructions in non-transitory memory.

The controller 192 may receive various signals from sensors 195 coupled to various regions of the electric drive 100. For example, the sensors 195 may include a rotor current sensor, an electric machine speed sensor, a stator current sensor, an electric machine temperature sensor, an auxiliary contact sensor, a battery state of charge sensor, an inverter current sensor, and the like. Electric machine speed may be ascertained from the amount of power sent from the inverter 108 to the electric machine 104. An input device 198 (e.g., an accelerator pedal, a brake pedal, a drive mode selector, a gear selector, combinations thereof, and the like, in the EV example) may further provide input signals indicative of an operator's intent for electric drive control.

Although, one controller is depicted in FIG. 1, it will be understood that the electric drive and the system in which it is incorporated, such as a vehicle, may include multiple controllers. For instance, in the EV example, a vehicle control unit (VCU) may be included in the control system 190. Additionally, a motor control unit (MCU) may be included in the control system. In such an example, the VCU and the MCU may be distinct controllers with independent hardware and may be formed in separate enclosures which are spaced away from one another. However, in other examples, the VCU and the MCU may be collocated. In either case, the VCU and the MCU are in electronic communication with one another.

Upon receiving the signals from the various sensors 195 of FIG. 1, the controller 192 processes the received signals, and employs various actuators 196 of the electric drive components to adjust the components based on the received signals and instructions stored on the memory of controller 192. For example, the controller 192 may receive a signal indicative of an operator's request for increased electric machine output. In response, the controller 192 may command operation of the inverter 108 to adjust the electric machine's mechanical power output and increase the power delivered from the electric machine 104 to the downstream components 128. The other controllable components in the electric drive may function in a similar manner in relation to sensor inputs and command outputs.

An axis system is provided in FIG. 1 as well as FIGS. 2-7 for reference, when appropriate. The y-axis may be a vertical axis (e.g., parallel to a gravitational axis), the z-axis may be a lateral axis (e.g., horizontal axis), and the x-axis may be a longitudinal axis, in one example. However, in other examples, the axes may have other orientations. Further, a central axis 180 (e.g., a rotational axis) of the electric machine 104 is provided in FIG. 1 for reference as well as FIGS. 2-7, when appropriate.

FIG. 2 shows an example of an electric machine 200 with a housing 202 that encloses a stator 204 and a rotor 206. A cover 208 is coupled to an axial side 210 of the housing 202. A gap, formed between the cover 208 and a side surface 212 of the stator 204 is filled with multiple shims and/or springs 214 (e.g., wave springs, coil springs, polymer springs, combinations thereof, and the like). The number of shims and/or springs may be selected based on tolerances in the cover, the housing, and the stator as well as the target clamp load for the stator.

A gap 216 may be arranged between an inner diameter 218 of the housing 202 and an outer diameter 220 of the stator 204. In this way, the stator may be clearance fit within the housing. Thus, contact on the majority of stator outer surface is prevented, allowing deflections that are not transmitted directly to the housing (potentially reducing noise, vibration, and harshness (NVH)). Further, in one example, a softer material may be used in the axial clamp direction to dampen some vibration from stator into the housing and connection points. The stator 204 shown in FIG. 2 is serviceable and therefore is able to be uninstalled with less likelihood of stator or housing degradation. An attachment device 222 (e.g., a bolt, a screw, combinations thereof, and the like) may be used to removably attach the cover 208 and the housing 202.

FIG. 3 shows another example of an electric machine 300 that again includes a housing 302 and a stator 304. An intermediate cover plate 306 is removably attached to the housing 302 via an attachment device 308 that threaded into a housing bore 310, in the illustrated example. End windings 312 of the stator 304 are positioned circumferentially inward from the intermediate cover plate 306. The stator 304 further includes windings 314 that are electrically connected to the end windings 312 and extend through a stator core 316.

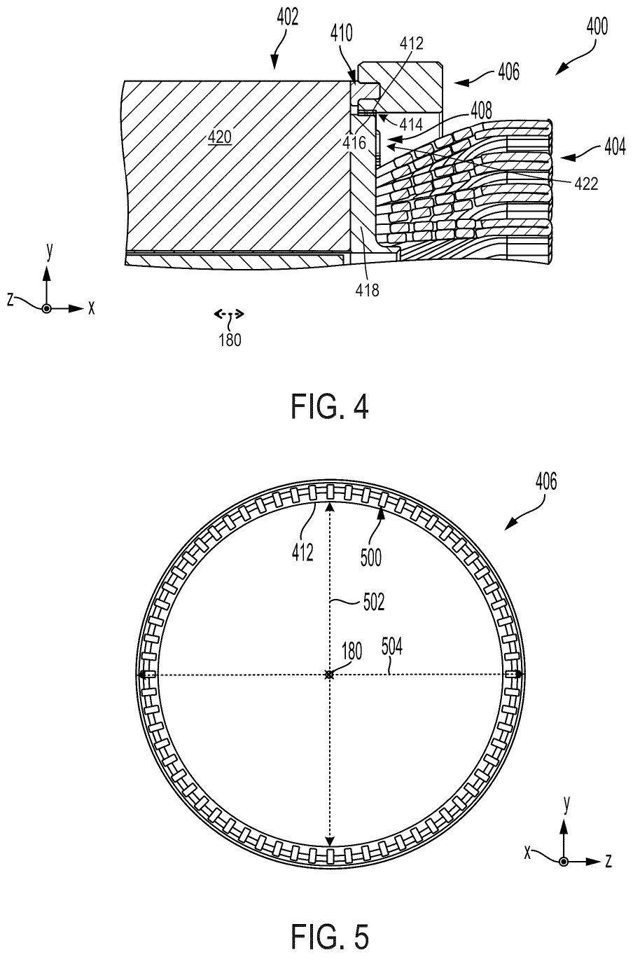

FIG. 4 shows another example of an electric machine 400. The electric machine 400 again includes a stator 402 with end windings 404. A threaded nut 406 is threadingly engaged with an axial side 408 of the stator 402. The threaded nut 406 is positioned circumferentially outward from the end windings 404. A vibration isolation material 410 may be positioned between the threaded nut 406 and the stator 402. In this way, noise, vibration, and harshness (NVH) in the electric machine may be reduced.

The threaded nut 406 includes threads 412 that form a threaded interfaced 414 with threads 416 in the stator 402. To elaborate, the threads 412 are arranged at an inner diameter of the threaded nut and the threads 416 are positioned on an end plate 418 of the stator 402. However, other locations of the threads in the threaded nut and the stator are possible. The end plate 418 is coupled to a stator core 420. To elaborate, the end plate 418 is coupled to an axial side 422 of the stator core 420. The end windings 404 extend through the end plate 418, in the illustrated example.

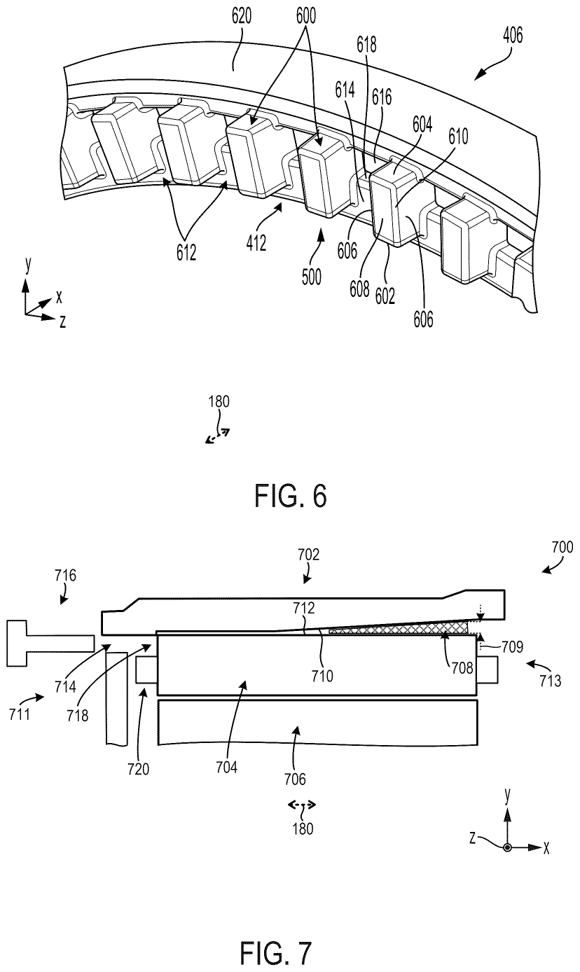

FIGS. 5-6 show detailed views of the threaded nut 406. The threaded nut 406 includes a tool interface 500 configured to interact with a spanner or custom tool that allows the nut to be torqued during installation and removal. In this way, a target stator compression can be achieved during manufacturing and allowing the stator to be efficiently disassembled during repair, maintenance, etc.

FIG. 5 specifically shows the threads 412 on the inner diameter 502 of the threaded nut 406. An outer diameter 504 of the threaded nut 406 is also indicated in FIG. 5.

FIG. 6 shows a detailed view of the threaded nut 406 that reveals the geometry of the tool interface 500. In the illustrated example, the tool interface 500 includes polygonal solids 600 (e.g., rectangular solids) that are evenly spaced about the threaded nut with regard to the central axis 180. However, other tool interface geometries are possible. Each of the solids 600 includes an inner side 602, an outer side 604, lateral sides 606, and an end face 608. The solids 600 may also include chamfered surfaces 610 between the sides and faces. However, other tool interface contours are possible.

The tool interface 500 may further include recesses 612 between the solids 600. The recesses 612 may include stepped surface 614 and an axially aligned surface 618 that abuts the stepped surface 614. The tool interface 500 further includes a recess 616, in the illustrated example. However, other contours of the tool interface are possible. FIG. 6 further shows the threads 412. FIG. 6 further depicts the threaded nut 406 with an outer surface 620 which is smooth. However, in alternate architectures, the outer surface 620 of the threaded nut 406 may be threaded.

FIG. 7 shows another electric machine 700 with a housing 702, a stator 704, and a rotor 706. The electric machine 700 further includes a conical wedge device 708 positioned between an inner diameter 710 of the housing 702 and an outer diameter 712 of the stator 704 to lock the stator in place while allowing for stator removal. The conical wedge device 708 may be threadingly engaged with the housing 702 and/or or otherwise removably attached thereto. In this way, the stator is retained in a similar manner to a press-fit stator, but without the need for a thermal heat/shrink fit operation, if desired. Further, the stator retention techniques described herein do not demand large bosses on stator laminations or expanded cavity in motor housing to house long bolts along the entire length of stator, if desired. In this way, the stator may be more securely and space efficiently retained with the housing when compared to more complex stator retention systems. In such an example, the stator may not include bosses (e.g., bolt bosses) in the outer housing.

The conical wedge device 708 shown in FIG. 7 has a conical shape in the z-y plane, in the illustrated example. Further, in the illustrated example, a radial thickness 709 (as measured from a radial axis with an origin at the machine's rotational axis) tapers (e.g., linearly tapers) in a direction toward an axial side 711 of the machine where a threaded screw 716 otherwise referred to as an extraction screw resides. The threaded screw 716 is discussed in greater detail below. The conical wedge device 708 may be inserted into the machine at an axial side 713 of the machine. The axial sides 711 and 713 are axial opposing sides.

The electric machine 700 further includes a threaded interface 714 in the housing 702 that is profiled to receive the threaded screw 716 which allows the stator to be efficiently extracted from the housing 702. To elaborate, when the screw 716 is threaded into the threaded interface 714, an end of the screw contacts an axial side 718 of the stator 704. The threaded interface 714 may be positioned such that the screw 716 contacts the stator radially outward from end windings 720.

FIGS. 1-7 and the corresponding description provide for a method for manufacture of an electric machine system. The method includes, in one example, mating an assembly formed between a multi-phase stator and a rotor with a housing. The method further includes securing the assembly within the housing using a stator retaining device. In such an example, the stator retaining device includes a wedge ring positioned between an outer diameter of a stator lamination stack and an inner diameter of the housing, a cylindrical nut coupled to an axial end of the stator lamination stack and the housing, wherein the threaded nut and exerts an axial clamp load on the stator lamination stack, or a cover and one or more shims and/or springs positioned axially between the cover and the stator lamination stack, wherein the cover is coupled to the housing. In one example, the wedge ring may be positioned on a first axial side of the multi-phase stator and the method may further comprise: unmating the assembly from the housing via threading an extraction screw into a threaded interface that is positioned on a second axial side of the multi-phase stator that opposes the first axial side. Further, in one example, securing the assembly within the housing using the stator retaining device may include threading the cylindrical nut into the housing; and wherein the cylindrical nut may include threads on an outer diameter that engage threads on the inner diameter of the housing.

FIGS. 1-7 shows example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Additionally, elements co-axial with one another may be referred to as such, in one example. Further, elements shown intersecting one another may be referred to as intersecting elements or intersecting one another, in at least one example. Further still, an element shown within another element or shown outside of another element may be referred as such, in one example. In other examples, elements offset from one another may be referred to as such. Further in other examples, the relative position of elements may be delineated via radial axes, circumferential directions, inboard and outboard directions, and the like.

The invention will be further described in the following paragraphs. In one aspect, an electric machine system is provided that comprises a housing circumferentially surrounding a stator; a cover removably coupled to the housing; and multiple shims and/or springs arranged between an axial end of the stator and the cover; wherein the shims and/or springs preload the stator; and wherein a clearance fit is formed between an inner diameter of the housing and an outer diameter of the stator. In one example, the electric machine system may be included in an electric powertrain.

In another example, an electric machine system is provided that comprises a housing circumferentially surrounding a stator; and a threaded nut removably coupled to an axial side of the stator; wherein a clearance fit is formed between an inner diameter of the housing and an outer diameter of the stator. In one example, the electric machine may further comprise a vibration isolation device positioned axially between the stator and the threaded nut. In another example, the threaded nut may be positioned radially outward from a stator end winding.

In another example, an electric machine system is provided that comprises a housing circumferentially surrounding a stator; and a conical wedge device arranged between an inner diameter of the housing and an outer diameter of the stator. In one example, the housing may include a threaded opening configured to receive a threaded extractor screw.

In another aspect, an electric machine system is provided that comprises a multi-phase stator circumferentially surrounding a rotor; a housing at least partially enclosing the multi-phase stator; and a stator retaining device configured to secure the multi-phase stator within the housing;
wherein the stator retaining device includes: a wedge ring positioned between an outer diameter of a stator lamination stack and an inner diameter of the housing; a cylindrical nut coupled to an axial end of the stator lamination stack and the housing, wherein the threaded nut and exerts an axial clamp load on the stator lamination stack; or a cover and one or more shims and/or springs positioned axially between the cover and the stator lamination stack, wherein the cover is coupled to the housing. In one example, the wedge ring may be positioned on a first axial side of the multi-phase stator and the housing may include a threaded interface positioned on a second axial side of the multi-phase stator that opposes the first axial side, wherein the threaded interface may be configured to receive an extraction screw. In another example, the springs may be wave springs. In another example, the cover may be coupled to the housing via a bolt. In another example, the bolt may not extend beyond an axial mid-line of the multi-phase stator. In another example, when the stator retaining device includes the cover and the one or more shims and springs, a gap may be formed between an outer diameter of the stator lamination stack and the inner diameter of the housing. In another example, the cylindrical nut may include threads that are positioned on an outer diameter and that engage threads on the inner diameter of the housing. In yet another example, the electric machine system may further comprise a dampening ring positioned axially between the cylindrical nut and the stator lamination stack. In another example, the cylindrical nut may be positioned axially inboard of stator windings. In another example, the cylindrical nut includes a tooling interface on an outboard axial side thereof. In another example, the tooling interface may include a plurality of teeth that are circumferentially arranged around a body of the cylindrical nut. In another example, a gap may be formed between an outer diameter of the stator lamination stack and the inner diameter of the housing.

In another aspect, a method for manufacture of an electric machine system is provided that comprises mating an assembly formed between a multi-phase stator and a rotor with a housing; securing the assembly within the housing using a stator retaining device; wherein the stator retaining device includes: a wedge ring positioned between an outer diameter of a stator lamination stack and an inner diameter of the housing; a cylindrical nut coupled to an axial end of the stator lamination stack and the housing, wherein the threaded nut and exerts an axial clamp load on the stator lamination stack; or a cover and one or more shims and/or springs positioned axially between the cover and the stator lamination stack, wherein the cover is coupled to the housing. In one example, the wedge ring may be positioned on a first axial side of the multi-phase stator and the method further comprises: unmating the assembly from the housing via threading an extraction screw into a threaded interface that is positioned on a second axial side of the multi-phase stator that opposes the first axial side. In one example, securing the assembly within the housing using the stator retaining device may include threading the cylindrical nut into the housing; and wherein the cylindrical nut may include threads on an outer diameter that engage threads on the inner diameter of the housing.

In another aspect, a traction motor system is provided that comprises a multi-phase stator circumferentially surrounding a rotor; a housing at least partially enclosing the multi-phase stator; and a stator retaining device configured to secure the multi-phase stator within the housing;

wherein the stator retaining device includes: a wedge ring positioned between an outer diameter of a stator lamination stack and an inner diameter of the housing; a cylindrical nut coupled to an axial end of the stator lamination stack and the housing, wherein the threaded nut and exerts an axial clamp load on the stator lamination stack; or a cover and one or more shims and/or springs positioned axially between the cover and the stator lamination stack, wherein the cover is coupled to the housing. In one example, the cylindrical nut may include threads on an inner diameter that engage threads in the stator. In another example, the traction motor system may further comprise vibration isolating material positioned between the cylindrical nut and the stator. In another example, the threads in the stator may be included in an end plate. In another example, the cylindrical nut may include a tooling interface on an outboard axial side thereof.

While various embodiments have been described above, it should be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive. As such, the configurations and routines disclosed herein are exemplary in nature, and that these specific examples are not to be considered in a limiting sense, because numerous variations are possible. For example, the above technology can be applied to a variety of systems that include electric drives with different types of propulsion sources including internal combustion engines, in a hybrid vehicle example. The subject matter of the present disclosure includes all novel and non-obvious combinations and sub-combinations of the various systems and configurations, and other features, functions, and/or properties disclosed herein.

Note that the example control and estimation routines included herein can be used with various electric machine and/or system (e.g., powertrain system) configurations. The control methods and routines disclosed herein may be stored as executable instructions in non-transitory memory and may be carried out by the control system including the controller in combination with the various sensors, actuators, and other electric drive and/or system hardware in combination with the electronic controller. As such, the described actions, operations, and/or functions may graphically represent code to be programmed into non-transitory memory of the computer readable storage medium in the electric drive and/or the system. The various actions, operations, and/or functions illustrated may be performed in the sequence illustrated, in parallel, or in some cases omitted. Likewise, the order of processing is not necessarily required to achieve the features and advantages of the examples described herein, but is provided for ease of illustration and description. One or more of the illustrated actions, operations and/or functions may be repeatedly performed depending on the particular strategy being used. One or more of the method steps described herein may be omitted if desired.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An electric machine system, comprising:
a multi-phase stator circumferentially surrounding a rotor;
a housing at least partially enclosing the multi-phase stator; and
a stator retaining device configured to secure the multi-phase stator within the housing;
wherein the stator retaining device includes:
a wedge ring positioned between an outer diameter of a stator lamination stack and an inner diameter of the housing;
a cylindrical nut coupled to an axial end of the stator lamination stack and the housing, wherein the threaded nut and exerts an axial clamp load on the stator lamination stack; or
a cover and one or more shims and/or springs that are positioned axially between the cover and the stator lamination stack, wherein the cover is coupled to the housing.

2. The electric machine system of claim 1, wherein the wedge ring is positioned on a first axial side of the multi-phase stator and the housing includes a threaded interface positioned on a second axial side of the multi-phase stator that opposes the first axial side, wherein the threaded interface is configured to receive an extraction screw.

3. The electric machine system of claim 1, wherein the springs are wave springs.

4. The electric machine system of claim 3, wherein the cover is coupled to the housing via a bolt.

5. The electric machine system of claim 4, wherein the bolt does not extend beyond an axial mid-line of the multi-phase stator.

6. The electric machine system of claim 1, wherein, when the stator retaining device includes the cover and the one or more shims and springs, a gap is formed between an outer diameter of the stator lamination stack and the inner diameter of the housing.

7. The electric machine system of claim 1, wherein the cylindrical nut includes threads that are positioned on an outer diameter and that engage threads on the inner diameter of the housing.

8. The electric machine system of claim 7, further comprising a dampening ring positioned axially between the cylindrical nut and the stator lamination stack.

9. The electric machine system of claim 7, wherein the cylindrical nut is positioned axially inboard of stator windings.

10. The electric machine system of claim 7, wherein the cylindrical nut includes a tooling interface on an outboard axial side thereof.

11. The electric machine system of claim 10, wherein the tooling interface includes a plurality of teeth that are circumferentially arranged around a body of the cylindrical nut.

12. The electric machine system of claim 7, wherein a gap is formed between an outer diameter of the stator lamination stack and the inner diameter of the housing.

13. A method for manufacture of an electric machine system, comprising:
mating an assembly formed between a multi-phase stator and a rotor with a housing; and
securing the assembly within the housing using a stator retaining device;
wherein the stator retaining device includes:
a wedge ring positioned between an outer diameter of a stator lamination stack and an inner diameter of the housing;
a cylindrical nut coupled to an axial end of the stator lamination stack and the housing, wherein the threaded nut and exerts an axial clamp load on the stator lamination stack; or
a cover and one or more shims and/or springs that are positioned axially between the cover and the stator lamination stack, wherein the cover is coupled to the housing.

14. The method of claim 13, wherein the wedge ring is positioned on a first axial side of the multi-phase stator and the method further comprises:
unmating the assembly from the housing via threading an extraction screw into a threaded interface that is positioned on a second axial side of the multi-phase stator that opposes the first axial side.

15. The method of claim 13, wherein:
securing the assembly within the housing using the stator retaining device includes threading the cylindrical nut into the housing; and
wherein the cylindrical nut includes threads on an outer diameter that engage threads on the inner diameter of the housing.

16. A traction motor system, comprising:
a multi-phase stator circumferentially surrounding a rotor;
a housing at least partially enclosing the multi-phase stator; and
a stator retaining device configured to secure the multi-phase stator within the housing;
wherein the stator retaining device includes:
a wedge ring positioned between an outer diameter of a stator lamination stack and an inner diameter of the housing;
a cylindrical nut coupled to an axial end of the stator lamination stack and the housing, wherein the threaded nut and exerts an axial clamp load on the stator lamination stack; or
a cover and one or more shims and/or springs that are positioned axially between the cover and the stator lamination stack, wherein the cover is coupled to the housing.

17. The traction motor system of claim 16, wherein the cylindrical nut includes threads on an inner diameter that engage threads in the stator.

18. The traction motor system of claim 17, further comprising vibration isolating material positioned between the cylindrical nut and the stator.

19. The traction motor system of claim 17, wherein the threads in the stator are included in an end plate.

20. The traction motor system of claim 19, wherein the cylindrical nut includes a tooling interface on an outboard axial side thereof.
